(19) United States
(12) Patent Application Publication
(10) Pub. No.: US 2010/0306068 A1
(43) Pub. Date: Dec. 2, 2010

(54) ORDER RECEIVING SYSTEM AND TERMINAL DEVICE

(75) Inventor: Yoshifumi Sakamoto, Osaka City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 12/788,996

(22) Filed: May 27, 2010

(30) Foreign Application Priority Data
May 29, 2009 (JP) 2009-129763

(51) Int. Cl. G06Q 30/00; G06Q 10/00; G06Q 20/00; G06Q 50/00

(52) U.S. Cl. 705/15; 705/27; 705/21

(57) ABSTRACT

A terminal device according to the present invention is used, in a facility where a plurality of shops are collected, by a customer who purchases a product at any of the shops. The terminal device includes: a portion that displays a list of the plurality of shops, and has the customer specify a shop to be used from the shops in the list; a portion that displays a list of products carried by the shop to be used, and has the customer specify an ordered product from the products in the list; a portion that transmits information indicating the ordered product; a portion that receives information indicating that the ordered product can be handed over, and a portion that, when the reception is performed, provides to the customer a notification indicating that the ordered product can be received.

### CROSS-REFERENCE TO RELATED APPLICATIONS

This application is based on Japanese Patent Application No. 2009-129763 filed on May 29, 2009, the contents of which are hereby incorporated by reference.

### BACKGROUND OF THE INVENTION

1. Field of the Invention

The present invention relates to an order receiving system that receives orders for product purchase and the like and to a terminal device that is used as a terminal in the system.

2. Description of Related Art

In recent years, in facilities such as shopping malls, more and more food courts have been provided. In common food courts, a variety of restaurants are arranged side by side, and seats common to the restaurants are available. With these food courts, it is possible for the side of the facilities to save space by providing common seats. The food courts are also convenient for customers since various foods can be selected.

The customers here who utilize the food courts generally take the following actions. The customers first look around the restaurants to check their menus (possibly their items). After they decide menus to be ordered, they return to the restaurants dealing with such menus, and place orders and perform a settlement. Then, electronic beepers and the like for notifying the customers of the completion of the cooking are distributed to them, and the customers wait until the cooking is completed. Then, when the electronic beepers sound, the customers go back again to the restaurants, and exchange the electronic beepers for the menus.

As described above, in the food courts, the customers need to look around the restaurants in order to decide restaurants to be used and menus to be ordered, and also need to go to the restaurants to place orders. Hence, the customers are bothered because they have to move back and forth many times.

In particular, since the food courts are very crowded during lunch time or the like, it is significantly burdensome to move back and forth many times therein. When the customers are families or the like, they often place orders at a plurality of restaurants, and it is significantly burdensome for the customers to go to the restraints in crowded conditions.

### SUMMARY OF THE INVENTION

According to one aspect of the present invention, there is provided an order receiving system that receives, in a facility where a plurality of shops are collected, an order for product purchase at any of the shops, the order receiving system including: a shop terminal provided in each of the plurality of shops; and a customer terminal used by a customer who purchases a product at any of the shops. The order receiving system performs: processing in a first step in which the customer terminal displays a list of the plurality of shops, and has the customer specify a shop to be used from the shops in the list; processing in a second step in which the customer terminal displays a list of products carried by the shop to be used, and has the customer specify an ordered product from the products in the list; processing in a third step in which the shop terminal provided in the shop to be used displays the ordered product, and receives a first input indicating that the ordered product can be handed over; and processing in a fourth step in which, when the first input is provided, the customer terminal provides, to the customer, a notification indicating that the ordered product can be received.

### BRIEF DESCRIPTION OF THE DRAWINGS

The features and the like of the present invention become more apparent from the following description of the preferred example and the accompanying drawings showing the following.

FIG. 1 is a diagram showing the configuration of an order receiving system according to an embodiment of the present invention;

FIG. 2 is a diagram for showing a shop DB;

FIG. 3 is a diagram for showing a menu DB;

FIG. 4 is a diagram for showing an order control DB;

FIG. 5 is a sequence diagram (the first half) for processing performed in the order receiving system;

FIG. 6 is the sequence diagram (the second half) for the processing performed in the order receiving system;

FIG. 7 is a diagram for showing a display of the list of shops;

FIG. 8 is a diagram for showing a display of the list of menus;

FIG. 9 is a diagram for showing a display of a quantity input screen;

FIG. 10 is a diagram for showing a screen displayed when settlement processing is performed;

FIG. 11 is a diagram for showing a screen displayed when an order is received;

FIG. 12 is the diagram for showing the screen displayed when the order is received; and

FIG. 13 is the diagram for showing the screen displayed when the order is received.

### DETAILED DESCRIPTION OF PREFERRED EMBODIMENTS

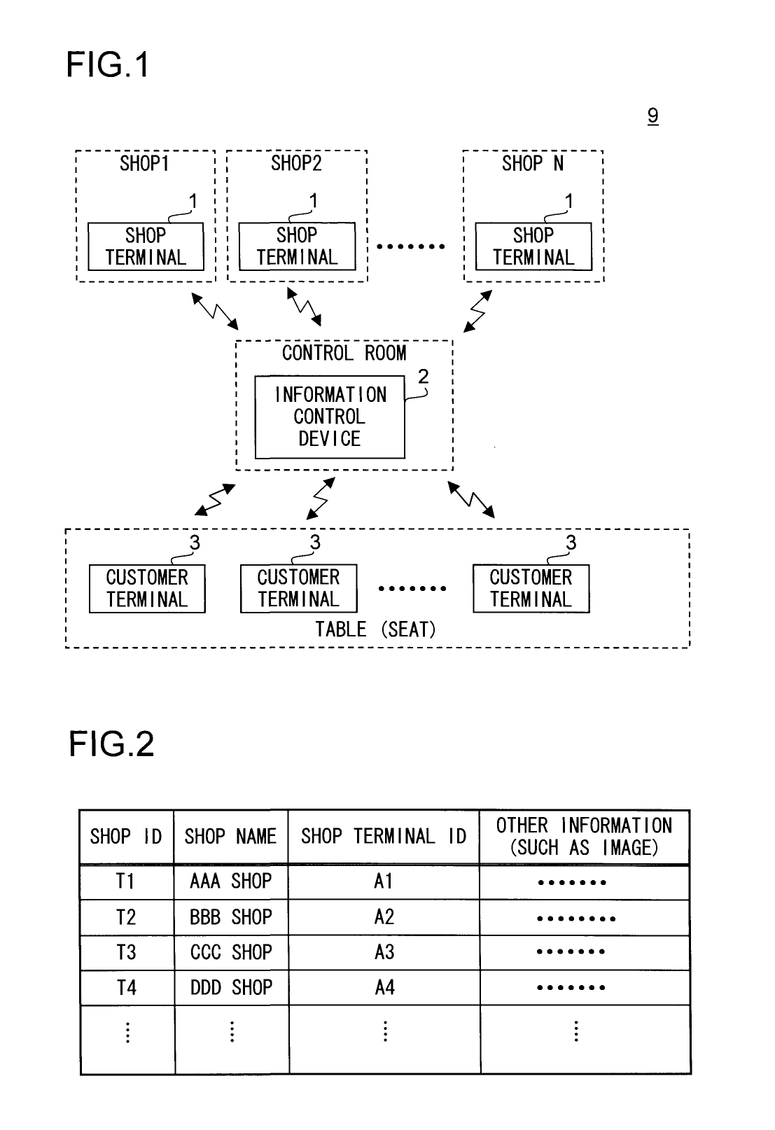

An embodiment of the present invention will be described below by way of example using an order receiving system that is employed in a food court. FIG. 1 is a diagram showing the configuration of the order receiving system. As shown in the figure, the order receiving system 9 includes shop terminals 1, an information control device 2 and customer terminals 3. The shop terminals 1 and the customer terminals 3 can be considered to be terminal devices that are used as terminals in the order receiving system.

The shop terminal 1 is provided in each of a plurality of shops located in the food court, and is intended to be used by the shop clerk of the shop. The shop terminal 1 includes a computation control device that performs predetermined processing and control, operation means (formed with a keyboard and the like) that receives an operation from the user (shop clerk), a display that displays various types of information and communication means that communicates with the information control device 2 and the like.

The information control device 2 is a device that controls various types of information in the order receiving system 9, and is placed in, for example, a control room of facilities (for example, a shopping mall) having a food court. The information control device 2 can wirelessly communicate with the shop terminals 1 and the customer terminals 3. When the shop terminals 1 and the customer terminals 3 transmit any information to the information control device 2, the ID information (the shop terminal ID or the customer terminal ID) of each terminal is also transmitted together therewith. Thus, the information control device 2 can recognize which one of the shop terminals 1 and the customer terminals 3 performs the transmission.

The information control device 2 includes a computation control device that performs predetermined processing and control and storage means (formed with a flash memory, a hard disk and the like) that stores various types of information. The information stored in the information control device 2 includes a “shop DB (database)” where information on the plurality of shops is collected, a “menu DB” where information on menus carried by the shops is collected and an “order control DB” where information on orders of the menus is collected.

The “shop DB” includes various types of information on the individual shops. Specifically, as shown in FIG. 2, shop IDs (different from one shop to another) allocated to the shops, the names of the shops and IDs (different from one shop terminal 1 to another) of the shop terminals 1 provided in the shops are included. Furthermore, the “shop DB” includes images (which are displayed on the customer terminals 3) showing the shops and information (such as the coordinates of positions of the images) that determines the states of the images displayed on the customer terminals 3.

The contents of the shop DB can be updated (addition, deletion, change and the like) according to instructions from the shop terminals 1. For example, when a shop clerk of a shop performs, with the shop terminal 1, an operation (such as for input of a new name) for changing the “name of the shop”, information or the like as to the new name is transmitted to the information control device 2 (in other words, an instruction to perform the update is provided), and the information control device 2 updates the shop DB as instructed.

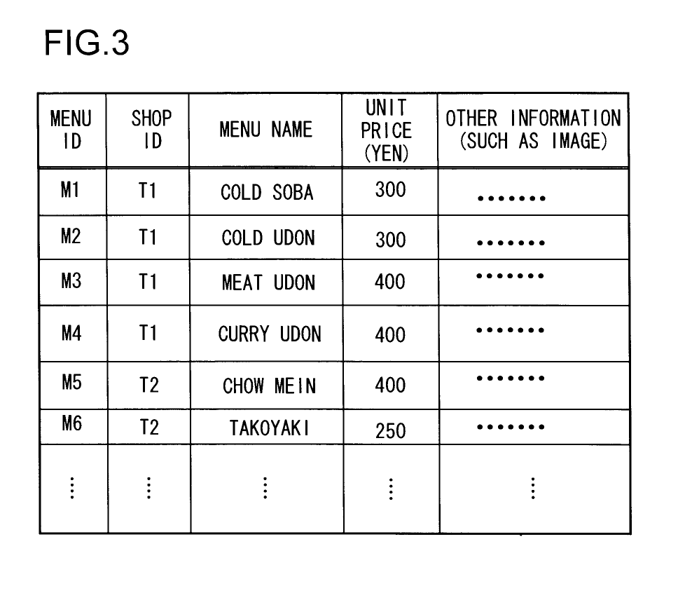

The “menu DB” includes various types of information on the individual menus. Specifically, as shown in FIG. 3, menu IDs (different from one menu to another) allocated to the menus, shop IDs for shops that carry the menus, the names of the menus and the unit prices of the menus are included. Furthermore, the “menu DB” includes images (which are displayed on the customer terminals 3) showing the menus and information (such as the coordinates of positions of the images) that determines the states of the images displayed on the customer terminals 3.

The contents of the menu DB can also be updated (addition, deletion, change and the like) according to instructions from the shop terminals 1. For example, when a shop clerk of a shop performs, with the shop terminal 1, an operation (such as for input of information on a new menu) for adding a menu to the shop terminal 1, information or the like as to the new menu is transmitted to the information control device 2 (in other words, an instruction to perform the update is provided), and the information control device 2 updates the menu DB as instructed.

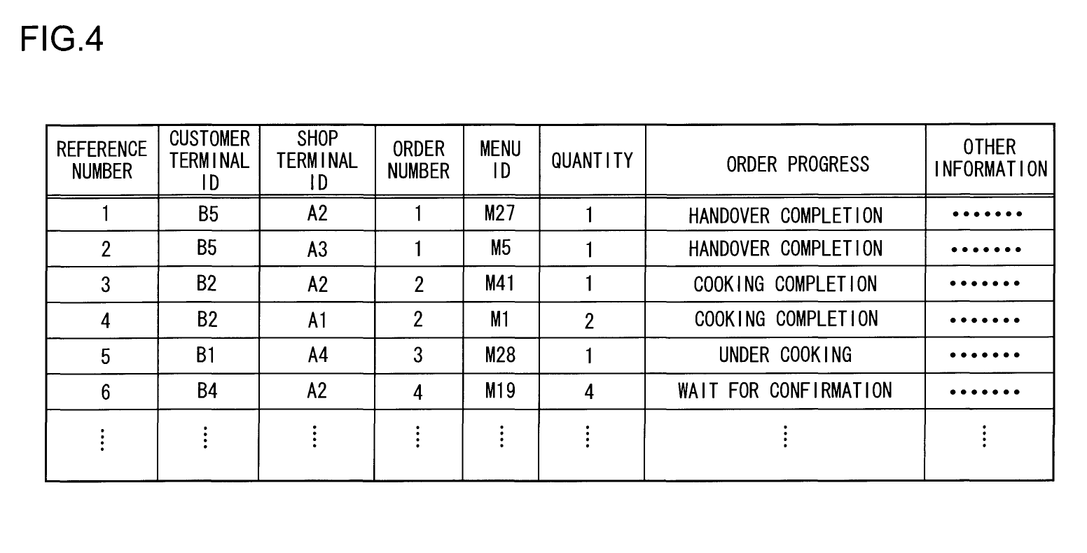

Since the menu DB can be updated by the shop terminals 1 in this way, for example, even when the menu is sold out or the unit price of the menu is desired to be changed due to time service, the shop clerk can easily handle it. The contents of the “order control DB” are as shown in FIG. 4; its details will be described later.

With reference back to FIG. 1, one or more customer terminals 3 are provided in each of tables (seats) placed in the food court, and they are intended to be used by the customers. The customer terminal 3 includes a computation control device that performs predetermined processing and control, a touch panel on which various types of information are displayed and through which an operation by the user (customer) is received and a storage device that stores various types of information. Furthermore, the customer terminal 3 includes a cash receiving device (having a cash insertion slot, a device that transports cash to the inside and stores it, means that detects the amount of money inserted and the like) that allows settlement processing and an order slip issuing device (having printing means, a space for storing slip forms and the like) for issuing an order slip.

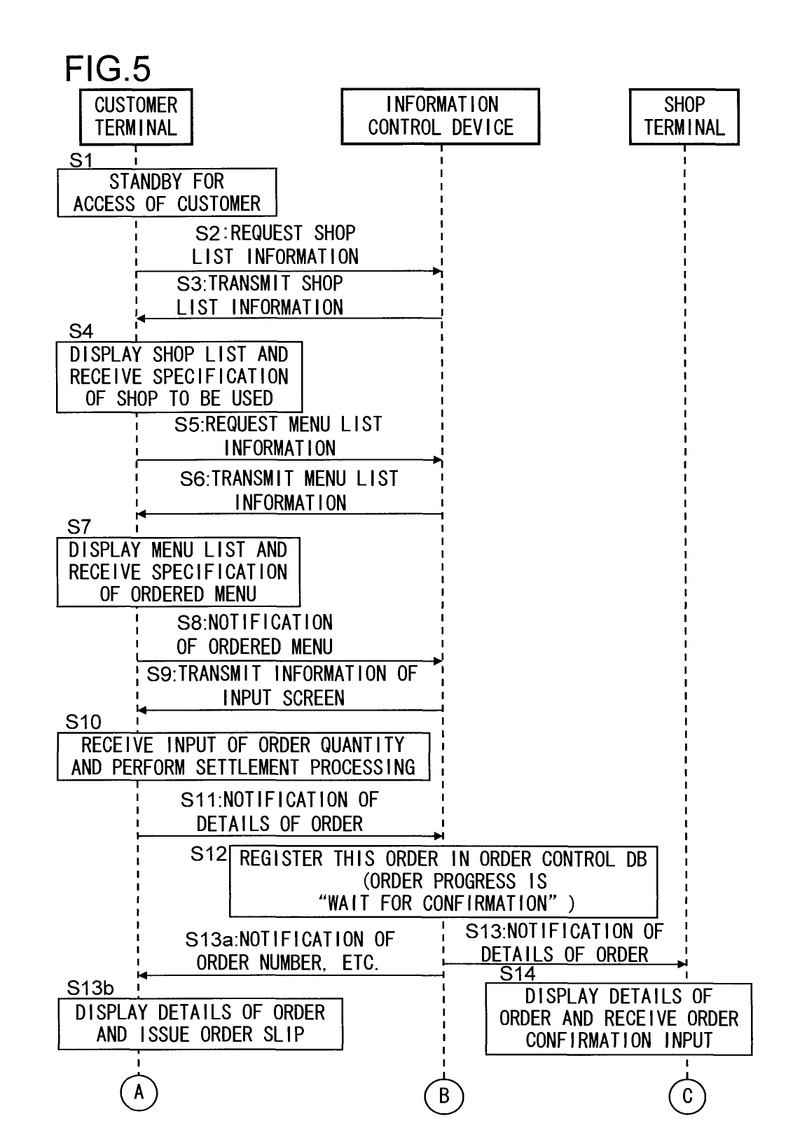

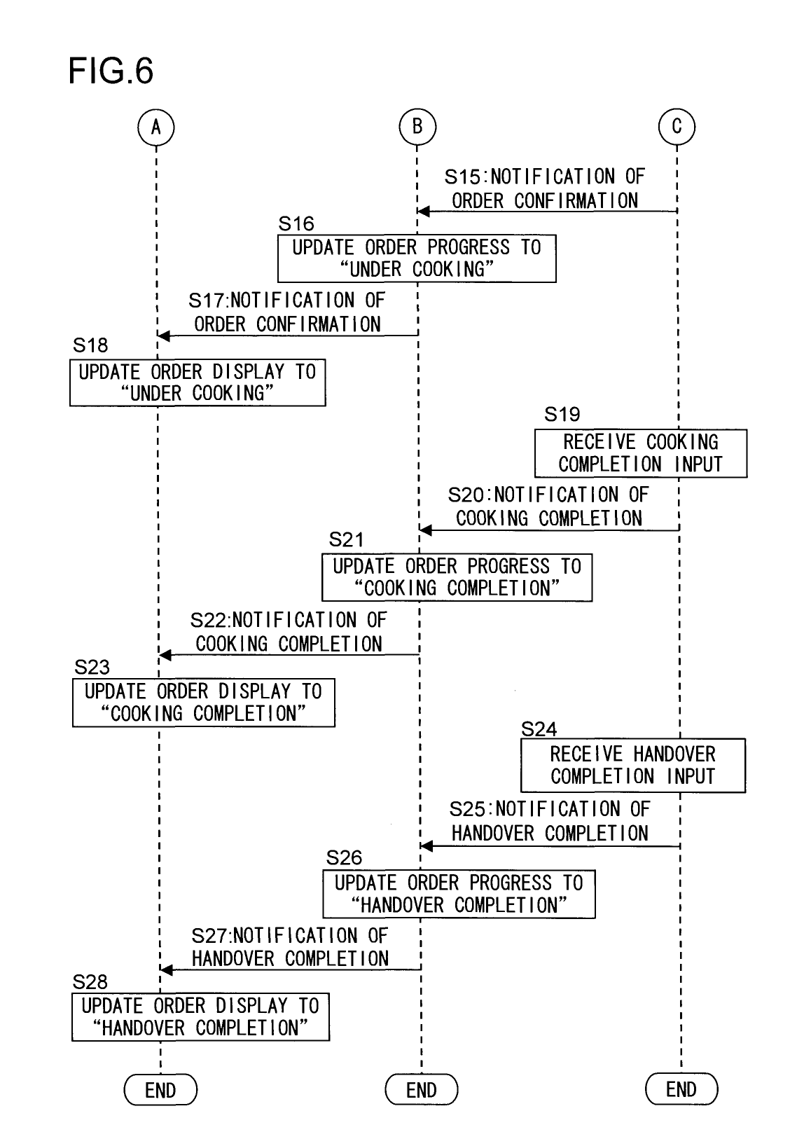

The order receiving system 9 configured as described above receives orders of menus from the customers and also performs processing on the orders. The process flow of processing performed in the order receiving system 9 will be described below with reference to a sequence diagram shown in FIGS. 5 and 6.

The customer terminal 3 is placed on standby for access (for example, a touch of the touch panel) from the customer (step S1). When the customer terminal 3 is accessed, the customer terminal 3 requests the information control device 2 to transmit shop list information (step S2).

When the information control device 2 receives the request for the transmission of the shop list information, it transmits the shop list information to the customer terminal 3 that has made the request (step S3). The shop list information includes the shop IDs of all the shops listed in the shop DB and image information (information for display of the list of the shops on the customer terminal 3).

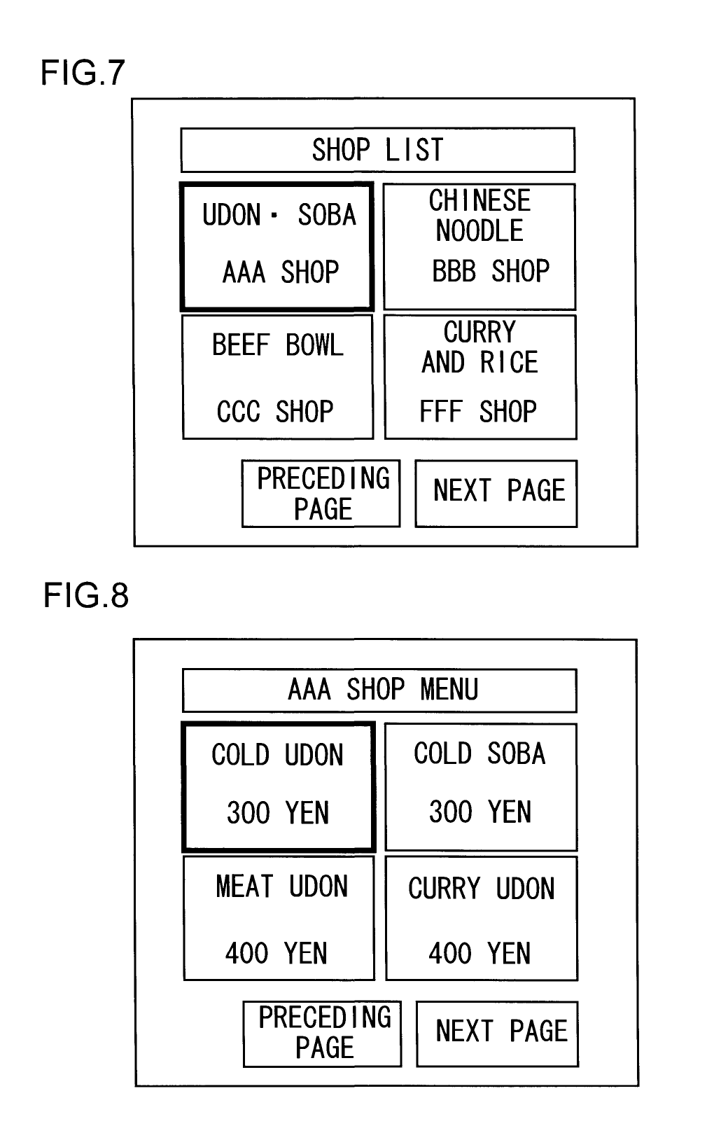

When the customer terminal 3 receives this shop list information, the customer terminal 3 displays the shop list based on the received shop list information, and receives an instruction to specify a shop to be used (shop where an order is placed) from the customer (step S4). Specifically, a list as shown in FIG. 7 (it is possible to display all the shops by selecting the “next page” or the like) is displayed on the touch panel of the customer terminal 3. When the customer touches the touch panel, a shop displayed on the touched portion is considered to be specified as the shop to be used.

When the shop to be used is specified, the customer terminal 3 transmits the shop ID of the shop to be used to the information control device 2, and requests it to transmit the list information (menu list information) of menus carried by the shop to be used (step S5). When the information control device 2 receives this shop ID, it transmits the menu list information to the customer terminal 3 that has made the request (step S6). The menu list information includes, among all the menus listed in the menu DB, the menu IDs of the menus carried by the shop to be used and image information (information for display of the list of the menus on the customer terminal 3).

When the customer terminal 3 receives the menu list information, it displays the menu list based on the received menu list information, and receives an instruction to specify a menu to be ordered from the customer (step S7). Specifically, a list as shown in FIG. 8 (it is possible to display all the menus by selecting the “next page” or the like) is displayed on the touch panel of the customer terminal 3. When the customer touches the touch panel, a menu displayed on the touched portion is considered to be specified as the ordered menu.

When the ordered menu is specified, the customer terminal 3 transmits the menu ID of the ordered menu (notifies the ordered menu) to the information control device 2 (step S8). When the information control device 2 receives this menu ID, it transmits information on a quantity input screen to the customer terminal 3 that has made the request (step S9). The information on the quantity input screen includes image information for display of the screen for receiving the input of an order quantity (how many menus are ordered) on the customer terminal 3.

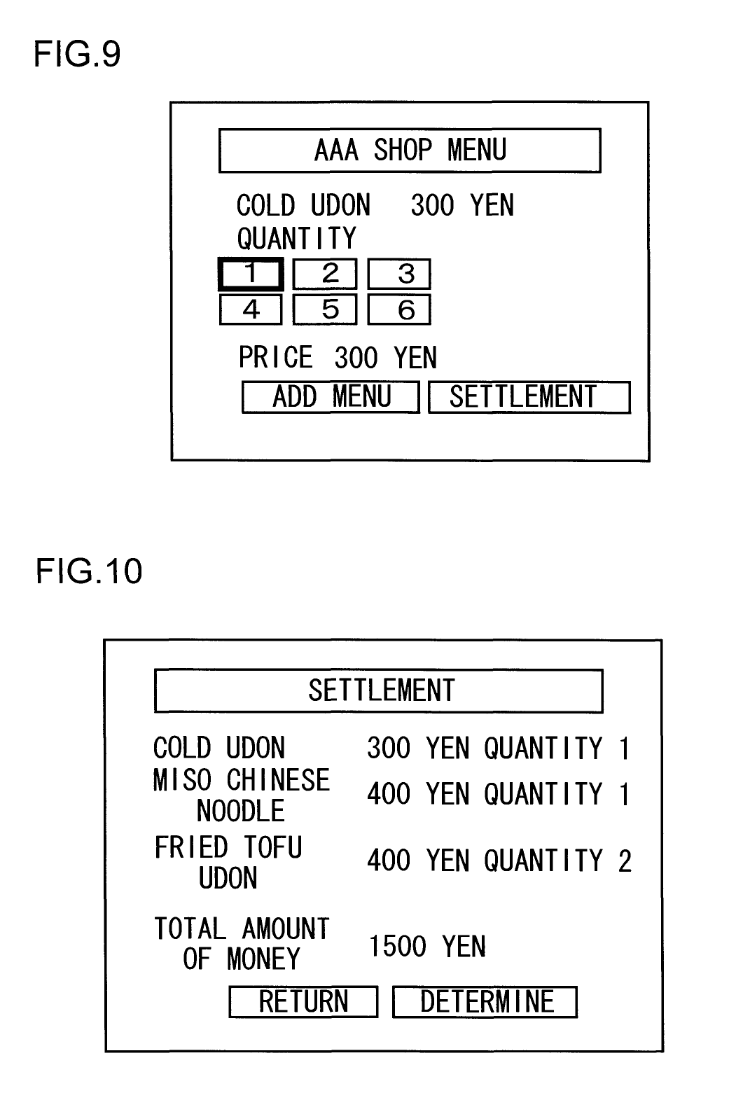

When the customer terminal 3 receives this information on the quantity input screen, it displays the quantity input screen as shown in FIG. 9 on the touch panel, and receives the input of an order quantity from the customer (step S10). When the customer touches the touch panel, a quantity displayed on the touched portion is considered to be input as the ordered quantity. By performing the processing described above, the menu desired to be purchased by the customer and its quantity are specified.

After the input of the ordered quantity, the customer can select any of “menu addition” and “settlement”. When the “menu addition” is selected, the order receiving system 9 again performs the processing in step 2 and the subsequent steps, and thereby adds a newly specified ordered menu to this order. In this way, the customer can order a plurality of types of menus (which may be carried by different shops) by placing an order, and can perform the associated settlement at the same time.

On the other hand, when the customer selects the “settlement”, a confirmation screen (where the ordered menus included in this order, the order quantities of the ordered menus, the total amount of money and the like are included) as shown in FIG. 10 is displayed on the touch panel of the customer terminal 3. The customer also can select any of “return” and “determine”. Then, when the “determine” is selected, the customer terminal 3 performs the settlement processing (processing for receiving the payment) on this order (step 10).

The settlement processing is achieved by receiving the insertion of cash equivalent to the total amount of money into the cash insertion slot provided in the customer terminal 3. It is possible to employ various methods for performing the settlement processing; the present invention is not limited to the method described above. For example, it is possible to employ a method for making the payment by prepaid card or credit card (in this case, a device for achieving each method is provided.)

After the settlement processing is completed, the customer terminal 3 notifies the information control device 2 of information (such as the menu IDs and order quantities of the ordered menus) for identifying the details of this order (step S11). When the information control device 2 receives this notification, it allocates an “order number” to information on this order that is placed by one customer or a group of customers with the customer terminal 3, and a reference number to each of the ordered menus of this order. Then, the information control device 2 registers the information on this order in the order control DB (step S12).

The order control DB includes various types of information organized by reference numbers. Specifically, as shown in FIG. 4, the IDs of the corresponding customer terminals 3 (through which the orders are received from the customers), the IDs of the corresponding shop terminals 1 (which are provided in the shops used), the corresponding order numbers, the menu IDs, the order quantities, the progress of the orders and the like are included. As described later, information on the progress of the orders is updated as necessary; the information is initially set to “wait for confirmation”. Afterward, processing is separately performed mainly on an individual order number basis and on an individual reference number basis, as will be clear from the following description.

The information control device 2 notifies the corresponding shop terminal 1 of the order number and the details of the order (such as the reference numbers, the menu IDs and the order quantities) organized by the reference numbers of the order number (step S13). When the shop terminal 1 receives this notification, it displays the details of the order that are notified and thereby provides a notification to the shop clerk, and receives an order confirmation input from the shop clerk (step S14). The shop clerk confirms the order number and the details of the order through the shop terminal 1, and recognizes, from the order number, that the order is received from the same customer, and provides the order confirmation input on an individual reference number, with the result that the cooking of the ordered menus is started.

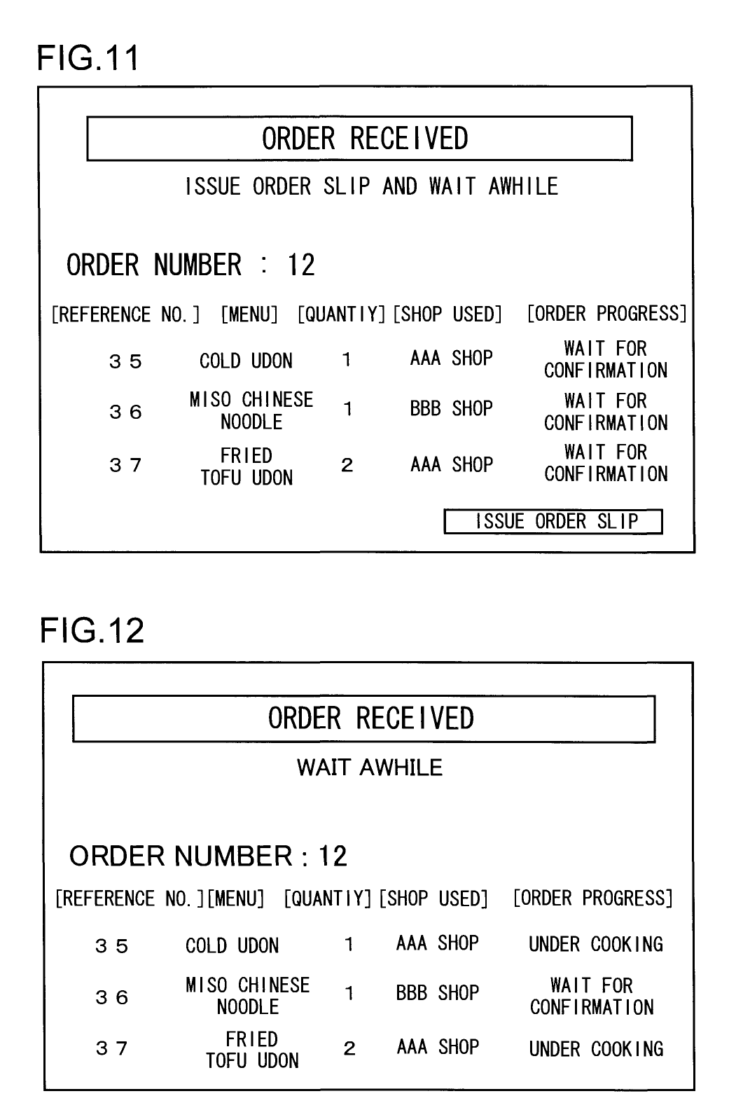

The information control device 2 notifies the customer terminal 3 of the order number, the reference numbers and the like (step S13a). When the customer terminal 3 receives this notification, it notifies, as shown in FIG. 11, the details of this order (including the progress of the order) to the customer, and displays, on the touch panel, a screen for prompting the customer to issue an order slip (step S13b). Then, when the customer selects “issue an order slip”, the customer terminal 3 issues the order slip (identifying the ordered menus and the like and serving as an exchange ticket for the ordered menus) in which the order number, the details of the order and the like are listed. Thus, the customer receives the order slip corresponding to the reference numbers. One order slip may be issued for each order; one order slip may be issued for all the orders placed by the customer. When one order slip is issued for all the orders, all shops and menus that are ordered are listed therein.

When an order confirmation input for a reference number of the order number is provided, the shop terminal 1 provides an order confirmation notification for the reference number to the information control device 2 (step S15). Thereafter, the shop terminal 1 receives, from the shop clerk, an input indicating the completion of the cooking (step S19). When the cooking of the ordered menu is completed (in other words, the menu becomes ready to be handed over to the customer), the shop clerk provides an input indicating the completion of the cooking of the menu (reference number), and waits for the reception of the menu by the customer.

When the information control device 2 receives the order confirmation input, the information on the progress of the order with respect to the reference number is updated to “under cooking” (step S16). Furthermore, the information control device 2 provides an order confirmation notification for the reference number to the customer terminal 3 that receives this order (step S17). When the customer terminal 3 receives this notification, it updates, as shown in FIG. 12, the display of the progress of the order for the reference number to the “under cooking” (step S18).

When the input indicating the completion of the cooking is provided (step S19), the shop terminal 1 notifies the information control device 2 of the completion of the cooking for the reference number (step S20), and then receives, from the shop clerk, an input indicating the completion of the handover (step S24). The shop clerk hands over the ordered menu to the customer in exchange for the order slip, and then provides an input indicating the completion of the handover of the menu (reference number) based on the information (such as the order name and the reference number) for identifying the ordered menu listed in the order slip.

When the information control device 2 receives the notification indicating the completion of the cooking, it updates the information on the progress of the order with respect to the reference number to “cooking completion” (step S21). Furthermore, the information control device 2 provides a notification indicating the completion of the cooking for the reference number of the order number to the customer terminal 3 that receives this order (step S22).

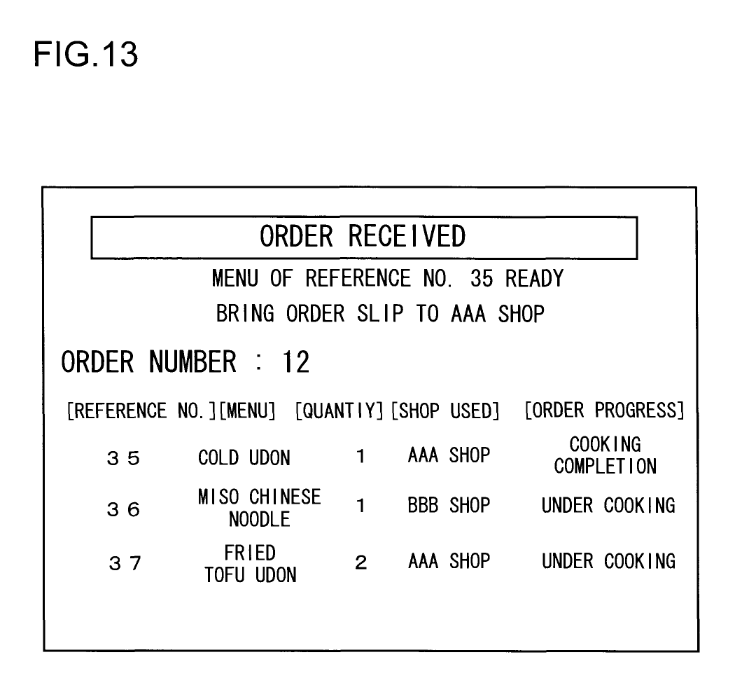

When the customer terminal 3 receives this notification, it updates, as shown in FIG. 13, the display of the progress of the order for the reference number to the “cooking completion”, and displays a message for encouraging the customer to receive the ordered menu (step S23). Thus, the customer goes to the shop used to receive the ordered menu with the order slip in hand.

When the input indicating the completion of the handover is provided (step S24), the shop terminal 1 notifies the information control device 2 of the completion of the handover for the reference number (step S25). Here, the shop terminal 1 completes the processing for the reference number. The information control device 2 receives the notification indicating the completion of the handover, and updates the information on the progress of the order with respect to the reference number to “handover completion” (step S26).

Furthermore, the information control device 2 notifies the customer terminal 3 receiving this order of the completion of the handover for the reference number (step S27). When the customer terminal 3 receives this notification, it updates the display of the progress of the order for the reference number to the “handover completion” (step S28). When the progress of the order for all the reference numbers of this order is updated to the “handover completion” (step S28), the customer terminal 3 completes the processing for this order.

With the order receiving system 9 that performs the processing described above, it is possible for the customer to check menus carried by the individual shops, order menus and perform a settlement of the ordered menus, using the customer terminal 3. Thus, since the customer can take these actions while keeping the seat, it is unnecessary for the customer to look around the individual shops and go to shops.

It is also unnecessary for the shop clerks of shops to receive orders directly from the customers and perform a settlement, and thus it is possible to smoothly perform their operations. As described above, with the order receiving system 9, it is possible to significantly improve convenience both for the customers and the shop clerks.

Since the order receiving system 9 independently performs processing at each stage on an individual order number basis or on an individual reference number basis, the order receiving system 9 can perform parallel processing on orders from a plurality of customers. The information control device 2 registers various types of advertisement information (including advertisement information on shops other than restaurants) on facilities having a food court (for example, a shopping mall), and distributes them to the customer terminals 3 as necessary (for example, according to customer requirements). The advertisement information may be previously distributed from the information control device 2 to the customer terminals 3, and the customer terminals 3 may store the advertisement information.

In this way, for example, after a meal, the customer can check, through the touch panel of the customer terminal 3, advertisement information such as bargain information on shops within the facilities. In the customer terminal 3, an order mode in which the orders of menus are received and an advertisement mode in which the advertisement information is displayed may be prepared, and theses modes may be switched according to the operations of the customers.

A device for distributing the advertisement information may be provided separately from the information control device 2. Alternatively, it may be possible for, for example, a manager of the facilities to check, as necessary, various types of information (such as the shop DB, the menu DB and the order control DB) recorded in the information control device 2.

As described above, the order receiving system 9 receives orders for menu (product) purchase at any of the shops in the facilities having the food court (facilities where a plurality of shops are collected). The order receiving system 9 includes the shop terminal 1 provided in each of theses shops and the customer terminal 3 used by the customer who purchase menus at any of the shops.

The order receiving system 9 performs: the processing (see step S4 and the like) in which the customer terminal 3 displays the list of these shops and has the customer specify a shop to be used from the shops in the list; the processing (see step S7 and the like) in which the customer terminal 3 displays the list of the menus carried by the shop to be used, and has the customer specify a menu to be ordered from the menus in the list; the processing (see steps S14 and S19 and the like) in which the shop terminal 1 provided in the shop to be used displays the ordered menu, and receives an input indicating the completion of the cooking (an input indicating that the ordered product can be handed over); and the processing (see step S23 and the like) in which, when this input is provided, the customer terminal 3 provides to the customer a notification indicating that the ordered menu can be received.

Although the above description deals with an example of the embodiment of the present invention, the invention is not limited to the details of the example. For example, although the above description deals with the case where the menu (food and drink) is used as an example of the product, the product is not limited to the menu. In the present invention, many modifications are possible without departing from the spirit of the invention.

An object of the present invention is to provide an order receiving system that can minimize the burdens of customers even when products are ordered in facilities, such as food courts, where a plurality of shops are collected.

According to one aspect of the present invention, there is provided an order receiving system that receives, in a facility where a plurality of shops are collected, an order for product purchase at any of the shops, the order receiving system including: a shop terminal provided in each of the plurality of shops; and a customer terminal used by a customer who purchases a product at any of the shops. The order receiving system performs: processing in a first step in which the customer terminal displays a list of the plurality of shops, and has the customer specify a shop to be used from the shops in the list; processing in a second step in which the customer terminal displays a list of products carried by the shop to be used, and has the customer specify an ordered product from the products in the list; processing in a third step in which the shop terminal provided in the shop to be used displays the ordered product, and receives a first input indicating that the ordered product can be handed over; and processing in a fourth step in which, when the first input is provided, the customer terminal provides, to the customer, a notification indicating that the ordered product can be received.

With this configuration, it is possible for the customer to check, through the customer terminal, the list of the shops and the list of the carried products, and specify any of the products to place an order. Thus, it is unnecessary for the customer to look around the shops to decide the shop to be used and the menu to be ordered, and to go to the shop to place the order. Consequently, even when products are ordered in facilities where a plurality of shops are collected, it is possible to minimize the burdens of customers.

In the above configuration, the customer terminal may include an accounting portion that performs a settlement of the product, and the processing in the third step may be performed after the settlement of the ordered product is completed by the accounting portion.

With this configuration, it is possible for the customer to perform a settlement through the customer terminal, and thus it is unnecessary to go to the shop to perform the settlement. Since the processing in the third step is performed after the settlement is completed, it is possible to eliminate a waste of preparing a product for a customer who does not perform a settlement.

In the above configuration, the shops are shops that sell food and drink, and the customer terminal may issue, after the completion of the settlement of the ordered product, an order slip identifying the ordered product. With this configuration, it is possible to hand over the product to the customer in exchange for the order slip, and hence, it is easily possible to smoothly hand over the product to the customer.

In the above configuration, an information control device may be further included that records shop information as to the shops and product information as to products carried by the shops and that can communicate with the shop terminal and the customer terminal. With this configuration, since the shop information and the product information are collectively controlled by the information control device, it is possible to easily control information.

In the above configuration, the shop information and the product information recorded in the information control device may be updated according to an instruction from the shop terminal. With this configuration, even when the shop information and the product information need to be updated, it is possible to cope with this situation.

More specifically, in the above configuration, when the processing in the first step is performed, the customer terminal may receive the shop information from the information control device and display the list of the shops based on the received information, and, when the processing in the second step is performed, the customer terminal may receive the product information from the information control device and display the list of the products carried by the shop to be used based on the received information.

In the above configuration, after the first input is provided, the shop terminal may receive a second input indicating that the handover of the ordered product is completed, and the information control device may record information on progress of the order which indicates any one of: a state shown after the processing in the third step is performed until the first input is provided; a state shown after the first input is provided until the second input is provided; and a state shown after the second input is provided. With this configuration, it is possible to easily control the progress of the order.

In the above configuration, the customer terminal may supply advertisement information as to the facility to the customer. With this configuration, it is possible to utilize the order receiving system as an advertisement medium.

According to another aspect of the present invention, there is provided a terminal device that is used, in a facility where a plurality of shops are collected, by a customer who purchases a product at any of the shops, the terminal device including: a shop-to-be-used specification reception portion that displays a list of the plurality of shops, and has the customer specify a shop to be used from the shops in the list; an ordered product specification reception portion that displays a list of products carried by the shop to be used, and has the customer specify an ordered product from the products in the list; an order information transmission portion that transmits information indicating the ordered product; a handover information reception portion that receives information indicating that the ordered product can be handed over, and a notification portion that, when the reception is performed, provides to the customer a notification indicating that the ordered product can be received.

In the above configuration, an accounting portion may be included that performs a settlement of the product, and furthermore an order slip identifying the ordered product may be issued after completion of the settlement of the ordered product.

According to yet another aspect of the present invention, there is provided a terminal device that is provided, in a facility where a plurality of shops are collected, in each of the plurality of shops, the terminal device including: an order information reception portion that receives information indicating an ordered product that is specified, by a customer who purchases a product at a shop to be used among the plurality of shops, from products carried by the shop to be used; an input reception portion that displays the ordered product and receives an input indicating that the ordered product can be handed over; and a handover information transmission portion that transmits, when the input is provided, information indicating that the ordered product can be handed over.

According to still another aspect of the present invention, there is provided an order receiving system that receives, in a facility where a plurality of shops are collected, an order for product purchase at any of the shops, the order receiving system including the terminal device configured as described above.

What is claimed is:

1. An order receiving system that receives, in a facility where a plurality of shops are collected, an order for product purchase at any of the shops, the order receiving system comprising:
a shop terminal provided in each of the plurality of shops; and
a customer terminal used by a customer who purchases a product at any of the shops,
wherein the order receiving system performs:
processing in a first step in which the customer terminal displays a list of the plurality of shops, and has the customer specify a shop to be used from the shops in the list;
processing in a second step in which the customer terminal displays a list of products carried by the shop to be used, and has the customer specify an ordered product from the products in the list;
processing in a third step in which the shop terminal provided in the shop to be used displays the ordered product, and receives a first input indicating that the ordered product can be handed over; and
processing in a fourth step in which, when the first input is provided, the customer terminal provides, to the customer, a notification indicating that the ordered product can be received.

2. The order receiving system of claim 1,
wherein the customer terminal comprises an accounting portion that performs a settlement of the product, and the processing in the third step is performed after the settlement of the ordered product is completed by the accounting portion.

3. The order receiving system of claim 2,
wherein the plurality of shops are shops that sell food and drink, and the customer terminal issues, after the completion of the settlement of the ordered product, an order slip identifying the ordered product.

4. The order receiving system of claim 2, further comprising:
an information control device that records shop information as to the plurality of shops and product information as to products carried by the shops and that can communicate with the shop terminal and the customer terminal.

5. The order receiving system of claim 4,
wherein the shop information and the product information recorded in the information control device can be updated according to an instruction from the shop terminal.

6. The order receiving system of claim 5,
wherein, when the processing in the first step is performed, the customer terminal receives the shop information from the information control device and displays the list of the plurality of shops based on the received information, and
when the processing in the second step is performed, the customer terminal receives the product information from the information control device and displays the list of the products carried by the shop to be used based on the received information.

7. The order receiving system of claim 4,
wherein, after the first input is provided, the shop terminal receives a second input indicating that the handover of the ordered product is completed, and
the information control device records information on progress of the order and the information indicates any one of: a state shown after the processing in the third step is performed until the first input is provided; a state shown after the first input is provided until the second input is provided; and a state shown after the second input is provided.

8. The order receiving system of claim 1,
wherein the customer terminal supplies advertisement information as to the facility to the customer.

9. A terminal device that is used, in a facility where a plurality of shops are collected, by a customer who purchases a product at any of the shops, the terminal device comprising:
a shop-to-be-used specification reception portion that displays a list of the plurality of shops, and has the customer specify a shop to be used from the shops in the list;
an ordered product specification reception portion that displays a list of products carried by the shop to be used, and has the customer specify an ordered product from the products in the list;
an order information transmission portion that transmits information indicating the ordered product;
a handover information reception portion that receives information indicating that the ordered product can be handed over, and
a notification portion that, when the reception is performed, provides to the customer a notification indicating that the ordered product can be received.

10. The terminal device of claim 9, further comprising:
an accounting portion that performs a settlement of the product.

11. The terminal device of claim 10,
wherein an order slip identifying the ordered product is issued after completion of the settlement of the ordered product.

12. A terminal device that is provided, in a facility where a plurality of shops are collected, in each of the plurality of shops, the terminal device comprising:
an order information reception portion that receives information indicating an ordered product that is specified, by a customer who purchases a product at a shop to be used among the plurality of shops, from products carried by the shop to be used;
an input reception portion that displays the ordered product and receives an input indicating that the ordered product can be handed over; and
a handover information transmission portion that transmits, when the input is provided, information indicating that the ordered product can be handed over.

13. An order receiving system that receives, in a facility where a plurality of shops are collected, an order for product purchase at any of the shops, the order receiving system comprising:
the terminal device of claim 9; and
a shop terminal device that is provided in each of the plurality of shops and that includes:
an order information reception portion that receives information indicating an ordered product that is specified, by a customer who purchases a product at a shop to be used among the plurality of shops, from products carried by the shop to be used;
an input reception portion that displays the ordered product and receives an input indicating that the ordered product can be handed over; and
a handover information transmission portion that transmits, when the input is provided, information indicating that the ordered product can be handed over.
